(19) United States
(12) Patent Application Publication
(10) Pub. No.: US 2005/0170775 A1
(43) Pub. Date: Aug. 4, 2005

(54) Method of data transmission between mobile telephones

(75) Inventor: Georg Rose, Dusseldorf (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/506,403

(22) PCT Filed: Feb. 28, 2003
(86) PCT No.: PCT/IB03/00771

(30) Foreign Application Priority Data
Mar. 7, 2002 (DE) 102 10 203.1

(51) Int. Cl. H04B 7/00

(52) U.S. Cl. 455/41.2; 455/414.1; 455/517

(57) ABSTRACT

A method of data transmission between mobile telephones, wherein a request signal is sent from a first mobile telephone via a wireless communication interface to a second mobile telephone, and the telephone number of the second mobile telephone is transmitted to the first mobile telephone.

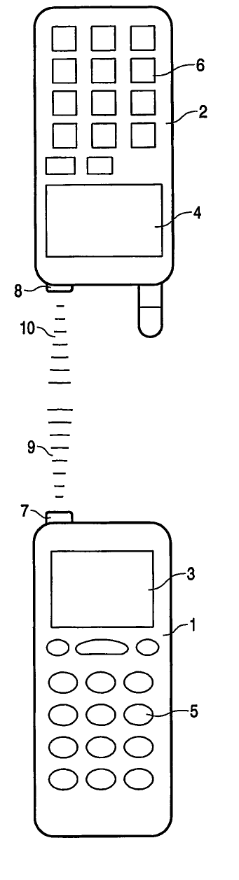

The invention relates to a method of data transmission between mobile telephones. It also relates to a mobile telephone with which the method according to the invention can be performed.

The number of users of mobile telephones is now very high and continues to increase. Mobile telephones are used practically everywhere, even in very noisy environments, for example during leisure events or conferences. In such cases, text messages must be sent and received in the form of SMS (short message service). One condition for this, however, is that the telephone number of the mobile telephone of the other person is known. However, situations are also conceivable in which addressing a neighbor is difficult or undesirable, for example in noisy environments or during conferences, so it is not possible to make contact via the mobile telephone. The same conditions apply if freedom of movement is greatly restricted, for example within a crowd of people. In this case, too, the mobile telephone of the contact cannot be reached.

The underlying object of the invention is, therefore, to create a method for data transmission between mobile telephones by means of which data of another mobile telephone can be obtained in order to establish contact.

This object is achieved with the method of the type mentioned in the opening paragraph, according to the invention, in that a request signal is sent from a first mobile phone via a wireless communication interface to a second mobile telephone, and the telephone number of the second mobile telephone is transmitted to the first telephone.

The initially unknown number of the mobile telephone of another person can be determined automatically by the process according to the invention. After transmission of the number of the second mobile telephone to the first mobile telephone, voice communication or data communication can take place between the two telephones. The method has the advantage that the telephone number can be safely transmitted even in noisy environments without the danger of mishearing. The users of the mobile telephones can transmit the telephone numbers noiselessly and imperceptibly so that other persons present are not disturbed, for example during a conference or any leisure event.

Preferably, an infrared interface is used as the wireless communication interface. Many mobile telephones are already fitted with an infrared interface, so that the method according to the invention can be implemented at relatively low cost. In order to trigger a data transmission between mobile telephones, the telephones with their infrared interfaces are set up so that the first telephone can send a request signal to the second telephone.

Advantageously, the telephone numbers are transmitted via the infrared interface. It may alternatively be provided, however, that the telephone numbers are transmitted via any radio connection, for example, a Bluetooth connection and/or a DECT connection and/or a GSM connection.

In a further embodiment of the method according to the invention, it may be provided that user-specific data of the second telephone can be in addition to the telephone number transferred. These may be the name of the user, his address, land line telephone number or, for example, e-mail address. It is also possible that the data contain information on his affiliation to a company or institution. In the same way as a business card, the user-specific data may contain various private or business information of the user of the second telephone. By the method according to the invention, all data can be simply transmitted to the first mobile telephone. The user of the first telephone then has the necessary information to make contact with the user of the second telephone at a later time.

It is expedient if, in a method according to the invention, a message is sent from the first mobile telephone to the second mobile telephone. This message may be sent before the data transfer, but may, however, alternatively confirm a successful data transfer. It may be provided that the message is formed as an SMS message which is sent to the now known number of the second mobile telephone. In this way, the owner of the second mobile telephone learns the telephone number of the first mobile telephone, so that a mutual data exchange takes place. Similarly, the SMS message may contain further user-specific data of the first mobile telephone.

A high security in data transmission is achieved in a method if after data transmission a signal is sent to the first and/or second mobile telephone. The signal may be an optical and/or acoustic and/or vibration signal which confirms the error-free data transfer. Similarly, a transmission fault can be indicated.

It may be provided for data protection reasons in the method according to the invention that the data transfer function can be switched off by the user at the second mobile telephone. Thus, the user can determine at which times data can be retrieved from his mobile telephone. It may also be provided that the user of the second mobile telephone must consent to each data transfer, so that the transmission of his telephone number or further data to unauthorized persons can be prevented.

According to a modification of the method according to the invention, it may be provided that the data transmission takes place as a function of fulfillment of a given or specifiable criterion. The criterion may be a user-specific profile and/or a filter. For example, the profile may be structured such that the telephone number is sent only to those mobile telephones which in turn provide their own telephone number. It may also be provided that the telephone number is transmitted only to mobile telephones which have a particular specifiable feature.

In order to perform a data transfer between several mobile telephones, it may be provided that the first mobile telephone displays those second mobile telephones which are ready for data transfer. This method is suitable, in particular, for a large group, for example in a conference. With the method according to the invention, participants can quickly check the numbers of the mobile telephones of other participants.

The mobile service provider can establish whether the data transmission takes place between all participants of a GSM network, between subscribers within a send/receive cell, or between subscribers of a defined group. This provides a possibility of testing the method according to the invention first in a particular cell and expanding it gradually. It may also be provided that each subscriber must be authorized before use of the method according to the invention, where applicable after payment of a fee.

The invention also relates to a mobile telephone which is designed for implementing the method according to the invention and a data transmission system which is formed by a plurality of such mobile telephones.

These and other aspects of the invention are apparent from and will be elucidated with reference to the embodiments described hereinafter.

The Figure shows a first mobile telephone 1 and a second mobile telephone 2. Each of the mobile telephones has a display 3, 4, input keys 5, 6, and an infrared interface 7, 8. When the user of the first mobile telephone 1 wishes to learn the telephone number of the second mobile telephone 2 without disturbing the other subscriber, for example during a conference, the mobile telephones 1, 2 are aligned to each other as shown in the Figure so that the two infrared interfaces 7, 8 can exchange data. The distance between the two mobile telephones 1, 2 may be substantially greater than shown in the Figure.

Data transfer begins by the first mobile telephone 1 sending a request signal 9 via the infrared interface 7 to the second mobile telephone 2. The request signal 9 is received by the infrared interface 8 of the second mobile telephone 2 and evaluated. In the embodiment shown, the user of the mobile telephone 2 has defined particular groups and persons to whom his telephone number should not be given. It is also possible, conversely, to define such groups or persons to whom transmission of the telephone number is permitted. After it has been established that the transfer of the telephone number of telephone 2 to telephone 1 is permitted, telephone 2 emits an acoustic signal to inform the user that his telephone number is to be transferred. The user activates a key on keypad 6 to declare his consent to the data transfer. Then, via the infrared interface 8, the telephone number of the mobile telephone 2 is transferred to mobile telephone 1 in the form of an infrared signal 10. This telephone number can be stored automatically in a memory of the mobile telephone 1. Besides the telephone number, the name of the user of telephone number 2 is additionally transferred.

The telephone number of mobile telephone 1 can then be transmitted in the same way to telephone 2. Telephone 1 using the GSM network can send an SMS message to telephone 2 whose telephone number is now known. The data transmission is concluded with this confirmation of the successful transfer of the telephone number.

1. A method of data transmission between mobile telephones, characterized in that a request signal is sent from a first mobile telephone to a second mobile telephone via a wireless communication interface, and the telephone number of the second mobile telephone is transmitted to the first mobile telephone.

2. A method as claimed in claim 1, characterized in that an infrared interface is used as the wireless communication interface.

3. A method as claimed in claim 1, characterized in that the telephone numbers are transmitted via an infrared interface and/or a radio connection, in particular a Bluetooth connection, a DECT connection, and/or a GSM connection.

4. A method as claimed in claim 1, characterized in that user-specific data of the second mobile telephone, such as a name and/or address and/or e-mail address, are also transmitted to the first mobile telephone.

5. A method as claimed in claim 1, characterized in that a message, preferably formed as an SMS message, is sent by the first mobile telephone to the second mobile telephone.

6. A method as claimed in claim 1, characterized in that an optical and/or acoustic and/or vibration signal is emitted at the first and/or the second mobile telephone after data transmission.

7. A method as claimed in claim 1, characterized in that the data transmission function can be switched off by the user at the second mobile telephone.

8. A method as claimed in claim 1, characterized in that the data transmission takes place as a function of fulfillment of a given or specifiable criterion.

9. A method as claimed in claim 8, characterized in that said criterion comprises a user-specific profile and/or filter.

10. A method as claimed in claim 1, characterized in that those second mobile telephones which are ready for data transmission are displayed on the first mobile telephone.

11. A method as claimed in claim 1, characterized in that the data transmission takes place between all subscribers of a GSM network, between subscribers within a send/receive cell, or between subscribers of a defined group.

12. A mobile telephone, characterized in that it is designed for implementing the method as claimed in claim 1.

13. A data transmission system, characterized in that it comprises a plurality of mobile telephones as claimed in claim 12.
